(19) United States
(12) Patent Application Publication
(10) Pub. No.: US 2015/0317863 A1
(43) Pub. Date: Nov. 5, 2015

(54) Dispenser of Ingredients For The Self-Preparation Of Food At A Sales Point

(71) Applicant: MERO KUALI TECNOLOGIAS S.A. DE C.V., Tampico, Tamaulipas (MX)

(72) Inventors: Mario Francisco Marino Chaix, Tampico, Tamaulipas (MX); Mauricio Marino Chaix, Tampico, Tamaulipas (MX); Carlos Humberto Casteneda Gobela, Tampico, Tamaulipas (MX); Manuel Martinez Martinez, Tampico, Tamaulipas (MX)

(21) Appl. No.: 14/649,050

(22) PCT Filed: Jul. 11, 2013
(86) PCT No.: PCT/MX2013/000084

§ 371 Date: Jun. 2, 2015

(30) Foreign Application Priority Data
Dec. 19, 2012 (MX) MX/A/2012/015151

(51) Int. Cl. G07F 17/00; G07F 9/10; G07F 13/02; G06Q 20/18

(52) U.S. Cl. CPC G07F 17/0078; G06Q 20/18; G07F 9/105; G07F 13/02

(57) ABSTRACT

The invention relates to a dispenser of ingredients for the self-preparation of food at a sales point, such as “esquites” (grilled corn) and “frijoles charros” (cowboy beans), the dispenser including a container having an essentially conical geometry, an automatic heat control device, a level sensor, a filling pump and an endless screw with a cylindrical cover that allows the projection of a certain amount of solid ingredients and the reduction of the quantity of liquid with which the main solid ingredient is served. The dispenser also includes a driving unit that drives the endless screw, a supporting structure, a central computer with units for communication with the internet, and spouts for additional seasoning, ingredients and flavoring.

### FIELD OF THE INVENTION

The system object of this invention belongs to the area of machinery for the semi-automatic processing and preparation of food, which is directly related to mechanical and electronic engineering and industrial design, also including concepts related to ergonomics and sanitary engineering.

### BACKGROUND OF THE INVENTION

Machines for vending products to the public date back to the time of splendour of ancient Greece when Hero of Alexandria built the first one in the 1st century A.D., which according to the weight of a coin placed on a lever, allowed a certain amount of water to flow until the currency slipped through the counterweight, and fell inside the machine, releasing the lever again and closing the valve. Devices for direct automatic sales have been present in everyday life for the last 2000 years but have undergone multiple modifications and refinements as technology has advanced and inevitably affects all human activity, and this is no exception. The most recent advances in automatic vending machines are machines that provide hot or cold drinks to customers, such as coffee, soft drinks or hot chocolate vending machines and others that dispense foodstuffs at room temperature such as potato crisps, chocolates and other foods packaged and containing preservatives to their deterioration in the short term.

The machine object of this invention, is designed to provide the customer at the sales point with the elements necessary to make a particular basically regional type of food which can be composed of different solid, liquid or creamy ingredients on the basis of using various grains, seeds or pulses that are kept in a hot liquid medium and which via a dosing mechanism allows the user to prepare a hot finished meal seasoned to his liking.

The design herein is particularly unique, because it is aimed at the preparation of various foods from certain regions whose needs in this respect have never been covered in this field.

### SUMMARY OF THE INVENTION

The dispenser of ingredients for the self-preparation of food at sales point object of this invention, responds to a need of the market to allow the possibility for anyone to acquire the necessary elements to prepare a hot regional dish themselves that can be seasoned with various ingredients to their taste, also achieving that all these elements that constitute both the raw material and the secondary ingredients and toppings remain available at all times in optimum conditions of hygiene, with minimum care and maintenance by the staff of the premises at the sales point.

The characteristics of this machine make it unique in its class since there is nothing similar currently available on the market, its modular construction allows for easy cleaning, installation, relocation and maintenance, the dispenser has the ability to be easily configured to supply the basic elements needed to produce foods such as “esquites” (grilled corn), which are heated corn kernels seasoned with cream, cheese, butter etc . . . , “frijoles charros” (cowboy beans), consisting of heated beans seasoned with onion, chili and other flavours of this stew according to its regional variations. The machine can likewise be used to prepare a wide variety of regional foods.

The dispenser is formed basically by a container designed with a specific geometry for keeping the main ingredient inside which is usually a grain or vegetable in a hot liquid, which is maintained at an ideal regulated temperature so that the product reaches the consumer in the most appealing manner in terms of shape, texture, flavour and temperature. Likewise, the high temperature helps to eliminate the possible proliferation of bacteria and pathogenic organisms in the food. The shape of the main container allows the extraction of solids and liquid in the necessary proportions and also facilitates cleaning and maintenance due to its special geometry. The main container has level sensors to control the amount of liquid inside, temperature sensors and a hatch that helps the container to stay properly closed until the exact moment that a certain amount of material should be poured into the container finally used by the consumer to eat the food, thus avoiding the contamination of the material located inside the main container by external element.

Once the main ingredient is deposited in the consumer's container, he can make use of complementary accessories that will allow him to add dressings and seasonings to his liking. In addition to the sensors that allow the dispenser to automate its operation, it also has motors and pumps that are responsible for the displacement of the fluids and ingredients and has also the ability to remotely notify the personnel responsible for its marketing and maintenance about the number of customers served, reserves of ingredients and information on the general status and operation of the machine in such a way that this information can be available through local audio-visual indicators, via internet or direct cell phone messages.

### DETAILED DESCRIPTION OF THE INVENTION

The dispenser of ingredients for the self-preparation of food at sales point object of this invention is a machine that allows some basic ingredients such as grains of corn, beans, chickpeas, rice etc. to be kept at a controlled temperature and available at any time to be used in the preparation of various regional foods, allowing flavourings and seasonings to be added to the taste of the consumer and according to each type of preparation. To make this possible the dispenser has a main container duly provided with thermally insulating coatings and built in such a way and a with a specific geometry that make it a modular unit that can be easily connected to a structural framework or support structure that gives it protection and additional insulation with regard to the installation environment, thus providing protection both to consumers and people who interact in the vicinity of the container and the container itself. The main container is the essential element of this design and consists of a module that can easily be removed from the support structure for cleaning and maintenance since it can be released without difficulty from the electrical, hydraulic and mechanical connections necessary for its operation. Said container has an essentially conical geometry and inside is placed a mixture of solid ingredients submerged in a liquid that provides the appropriate initial temperature, consistency and taste. In some cases such as in a machine for making “esquites”, water and seasoned cooked corn is placed inside the main container, when a customer wants to prepare esquite, the dispenser must provide the ideal ratio of liquid and corn in a container for the customer to then add butter, mayonnaise, cheese etc. as desired using different spouts for dispensing dressings and extra ingredients with which the dispenser is complemented and thus obtain a hot esquite properly prepared without requiring the services of an operator. The extraction of the appropriate proportion of solids and liquid from the machine is performed by an endless screw appropriately positioned along one of the sloping walls of the main container. The endless screw has a cylindrical transfer tube or cover that allows it to push out a certain amount of solid ingredients while it rotates while the tube covering the screw can have holes that act as a sieve and reduce the amount of liquid or moisture to the main solid ingredient. This effect achieved can also be achieved by leaving a free space between the endless screw and the transfer tube. At the end of this tube there is a hatch designed to keep the main container tightly closed. The consumer actuates the hatch via a lever which in turn actuates a switch that energises the motor driving the screw shaft so that the main ingredient will rise and can be poured through a specially designed spout, into a container which is provided to the consumer for placing under the spout and to be suitably filled with the basic ingredient, which in the case of esquites would be hot corn with a certain amount of humidity. The endless screw will rotate and project the corn from the main container while the consumer holds the lever in the position that maintains the output hatch. To prevent the same consumer from filling several containers at once, the dispenser can be equipped with an electronic control that ensures that the motor drives the endless screw for the necessary number of turns to allow the container to be filled just once.

FIG. 1 shows the typical appearance of an installation for the self-preparation of food at the sales point. In this figure we can observe the dispensing machine (1), which is responsible for providing the hot main ingredient to the consumer, which in the case of an installation for esquites is hot cooked corn, supplied to the consumer via a spout (3) whose output is released by the hatch (4), when the consumer operates the lever (24). The ingredient that is poured by the spout (3) will deposited into the serving container (2) which is usually a disposable cup or bowl. The installation usually has a base which (8) serves to attach the dispensing machine (1) at a an appropriate height and ergonomic position and a number of complementary ingredient dispensers (5), (6), (7) that the consumer can use to season or gamish the food, in the case of a machine for esquites, these complementary ingredients can be butter, mayonnaise, cheese, hot sauce, lemon etc.,

The central element of this design is the main container (11). In FIG. 2, we can see a cross-section drawing of the main container (11), which the endless screw that is used to push the food towards the outside has been removed in order to reveal how the granulated food lays at the bottom of this conical geometry. The main container (11) has a filling tube (10) through which liquid can be introduced inside the main container (11) as needed, to keep it at an appropriate level which is achieved by the action of the level sensor (25) which is responsible for constantly detecting the level of liquid with granulated food (12) inside the main container (11), when the level sensor (25) detects that the level of liquid with granulated food (12) is below a certain reference level, it sends a signal that activates a pump (27) as shown in FIG. 3 which draws liquid from the tank (28) to introduce it inside the main container (11). The food contained inside the main container (11) consists of a liquid part and a solid part and the liquid can be refilled through the action and monitoring of the level sensor (25), but if we want to increase the amount of solid material, this is filled through the filling hatch (18).

The liquid with granulated food (12) is maintained at a high temperature for two purposes, firstly to avoid the proliferation of pathogenic organisms and also for supplying the main ingredient to the consumer at a suitable temperature whenever required. This is achieved by a heating unit (17) shown in FIG. 2 which is supervised by the temperature sensor (26) so that the temperature sensor (26) maintains the temperature of the liquid with the granulated food (12) at a predetermined level. To avoid excessive use of energy to maintain the appropriate temperature levels, the main container (11), also has insulating structure consisting basically of an inner surface (20) and an outer surface (22) between which is an area of insulating material (21), this also allows the main container (11) to be handled as a module thus avoiding burns to staff. FIG. 2 also shows the placement of the motor (14), responsible for driving the endless screw (29) as can be seen in FIG. 4, but that in this FIG. 2 has been removed to facilitate the displaying of the other elements. The shaft (23) of the motor (14) penetrates inside the main container (11) through a hole equipped with a seal (16) unit which prevents liquid from spilling but at the same time allows the motor (14) shaft (23) to spin freely. The shaft (23) of the motor (14), has a quick action coupler (15), which allows the motor (14) to drive the endless screw (29), the coupler (15) can be a reverse threaded coupler, which consists of a cylinder threaded in one direction so that it can enter the free end of the endless screw (29) so that when the motor turns (14) to expel material from the inside the main container (11), the endless screw will tend to penetrate into the cylinder which constitutes the inside of the coupler (15) until it is automatically affixed. To release the endless screw (29), for cleaning or servicing, simply hold it with one hand while the motor (14) is made to turn in reverse to its normal operation. The coupler (15) also can be replaced with a grooved coupler with transverse pin as can be seen in FIG. 9. In this case the reverse-threaded coupler (15), has been replaced by a slotted coupler (40) that interacts with a transverse pin (32) fitted at the end of the endless screw (29).

The endless screw (29) is placed inside the transfer tube (13), as can be seen in FIG. 9. It is the action of the relative motion of the endless screw (29), with respect to the internal walls of the transfer tube (13) that propels the liquid with granulated food (12) towards the output area which is usually covered by the hatch (4) as can be seen in FIG. 2, leaving the output area clear for the spout (3) when the lever (24) is actuated to move the gate (4) which at the end of its travel triggers the switch (9) responsible for activating the motor (14) so that the endless screw (29) can proceed to move material from the bottom of the main container (11). FIG. 2 also shows how the (13) transfer tube can be equipped with sieve holes (19) to allow a certain proportion of the liquid to leak through these sieve holes (19) when the material is projected out in order to establish the correct ratio between the solids and liquids that constitute the main ingredient that will fill the serving container (2). This function can also be performed by leaving a small gap between the endless screw (29) and the transfer tube (13); this is seen more clearly in FIG. 9 which shows this escape gap (41) that can perform the same functions as the sieve holes (19).

FIG. 3 shows a block diagram of the dispenser to give a general overview of its operation, the tank (28), contains a certain amount of liquid (48) which is transferred through the action of the pump (27) under the command of the level sensor (25) so that the liquid part and solid part constituting the liquid with granulated food (12), remains inside the main container (11) within the limits of a predetermined level, when a consumer wants to prepare hot food such as, for example, esquites, once the corresponding payment has been made a serving container is provided (2) which is usually a disposable container and he will be allowed to operate the lever (24) which, in turn, releases the hatch (4), which normally blocks the passage to the inside of the main container (11). Once this action is performed the motor (14) is automatically activated that turns the endless screw (29), which revolves inside the transfer tube (13), allowing part of the liquid with the granulated food grain to be projected up and out to fill the serving container (2) through the spout (3) that has been exposed by moving the hatch (4) using the action of the lever (24). On the way up the fluid part of the liquid with granulated food (12), is strained through the sieve holes(19) or filtered through the escape gap (41) so that it stays inside the main container (11) to ensure that the material discharged into the serving container (2), has the correct ratio of liquids and solids. This ratio may be very high as in the case of frijoles charros or lower in the case of esquites where the kernels are barely covered in steam. The temperature sensor (26) is responsible for monitoring the temperature inside the main container (11) and generates the necessary actions to activate the heater (17), which is ultimately responsible for maintaining the temperature at its correct level.

FIG. 4 shows the dispensing machine (1) with the lever (24) and the serving container (2) as a consumer would see it. The front panels of the support structure (31) may be used to display advertising and instructions for use. FIG. 4 also shows the endless screw (29) coupled to the motor (14), which in this case is equipped with a gearbox (38) which is necessary for some applications where the solid material constituting the granulated food is very dense, the motor equipped with gearbox (38), has lower revolutions than a simple motor but provides greater torque to the endless screw (29), this figure also shows that the main container (11), is easily lodged inside the support structure (31) sustained by the supports (39) especially positioned and angled for that purpose, the outer surface (22) of the main container (11), is supported on the brackets (39) of the support structure (31); the filling tube (10) is connected to the filling hose (30), which allows the pump (27), to convey liquid into the main container (11) when this is required by the level sensor (25).

FIG. 5 shows various views of the main container (11) coupled to the hatch assembly (4), all in the form of a removable and compact module, the motor (14) is connected to the endless screw (29) by means of a quick-release coupling, in this case formed by the stud (32) and the sealing unit (16) prevents liquid from leaking to the outside. As shown in this embodiment, the endless screw (29) is installed semi-permanently in inside the transfer tube (13) and consequently inside the main container (11). With this configuration by removing the main container (11) the endless screw is removed also (29) and while the coupling assembly is simpler, it makes it a little more difficult to clean the endless screw (29).

The assembly of the hatch (4) the lever (24) and the spout (3), is shown more clearly in FIG. 6 which shows that the lever (24) can move around the axle (35) which is integrated into the fixed body (36). By moving the lever (24) downwards, the free end thereof, pushes the hatch (4) upwards against the force of the spring (33) and in so doing, the hatch (4), frees the spout (3). The cover (37) of the hatch affixes and consolidates the whole mechanism using wing nuts (34) also allowing quick access to the interior of the mechanism in the event of becoming stuck at some point.

FIG. 7 shows the main container (11), as a fully modular element equipped with its motor (14), the lever (24) which opens the spout (3), activates the motor (14) and consequently rotates the endless screw (29) via the gearbox (38) to transfer a certain amount of liquid with granulated food (12) into the serving container (2), the latter is shown in FIG. 7 for reference only.

FIG. 8 shows the assembly of the support structure (31), this structure supports and protects the main container (11); to which it is affixed in several areas such as the brackets (39). The support structure (31), also holds the filling tube (10) and pump (27) in a position which can be fixed or a submersible pump positioned in the tank (28) may be used.

The general idea is to have a modular unit or main container (11) that can be easily removed from the structure that supports and protects it, which in this case is the support structure (31). Said structure has outer panels so that the main container (11) is kept away from the operator, fulfilling the double function of protecting the interior of the machine and helping to maintain the temperature inside the main container (11) with a minimum of heat loss, since these panels restrict the airflow around the main container (11). Said panels can be seen in FIG. 11 and are comprised of the side panels (49) and (51), the top panel (50) and the front panels (52) and (53).

The operation of the dispenser of ingredients for the self-preparation of food at the sales point is complemented through the use of various electronic circuits for monitoring, control and communications, and while the dispenser can operate with these devices or without, its efficiency greatly improves by incorporating them to the system.

FIG. 10 shows a block diagram incorporating these complementary devices. A radio transmitter (43) can wirelessly send alarm signals or general status notifications of the installation, the number of clients served, notifications about the need to fill fluid, food or condiments reservoirs. This information can reach various destinations including cell phones, computers or a local information display panel. The system can also incorporate a central computer (44) which can optimize the operating parameters of the machine in real time, this central computer (44) may also have direct access to internet, which is very important because these dispensers are generally marketed by a company that is responsible for the maintenance, supply of raw materials and supervision of equipment installed in many different outlets, making it very useful to centralize the information of each of the machines installed. The central computer (44) has an operational interface (47) that allows voltage loads to be applied and communicates with the outside world via communication modules such as the radio transmitter (43) that can work with Bluetooth, Wi-Fi, 0-0-K, etc. The operational interface (47) allows the correct operation of the liquid loading pump (48) from the reserve tank (28) to the modular dispensing system (46) so that the liquid with granulated food (12) is always kept at an optimal level. The central computer (44) is also responsible for controlling the functions of the automatic payment system (45). The latter is a basic unit that accepts payment in different currencies so that once the payment of a service is recognised, the central computer (44), gives the consumer the possibility of operating the dispenser of ingredients for the self-preparation of food at the sales point. This function can also be performed by paying an employee directly over the counter when the payment unit is not operating. Finally there is the possibility of integrating an automatic supply unit for solids (42) to the system, also controlled by the central computer (44), for reducing supply visits to the unit.

### DESCRIPTION OF THE FIGURES

FIG. 1 shows the typical general appearance of the dispenser of ingredients for the self-preparation of food at sales point.

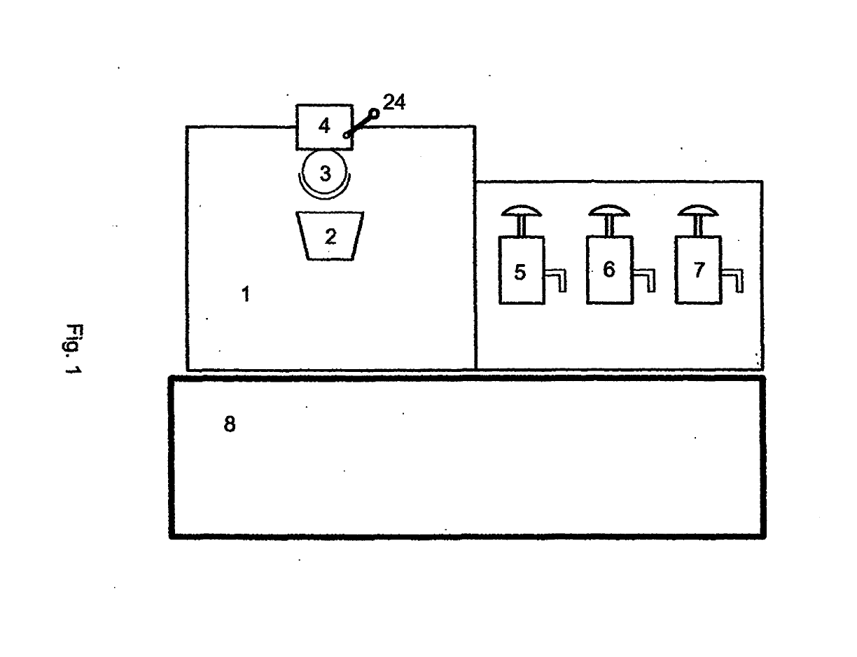

FIG. 2 shows a cross-section of the main container in which the heating unit, the motor and the main elements of this module can be seen including the switch that controls the motor, the lever and the hatch that release the spout, the temperature and liquid level sensors and the inlets for liquids and solids to the main container.

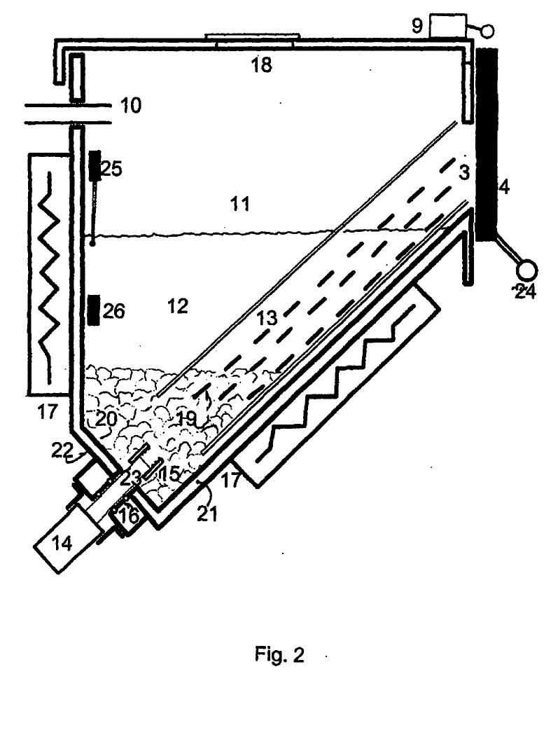

FIG. 3 is a block diagram showing the main elements of the dispenser of ingredients for the self-preparation of food at sales point and their interaction.

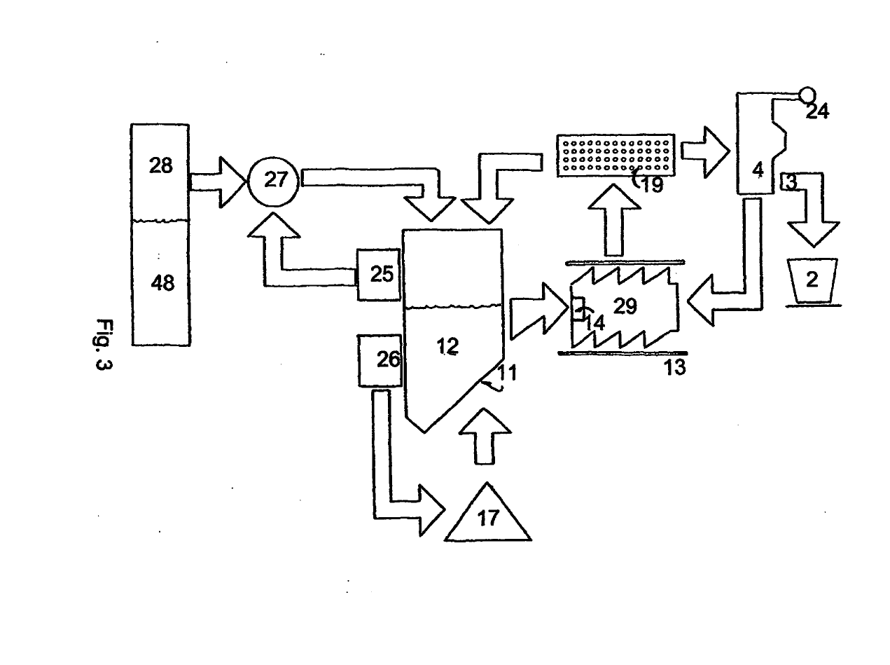

FIG. 4 shows the front view of the dispenser ready to fill a serving container, a cross section of the machine including the main container and the structure that supports it.

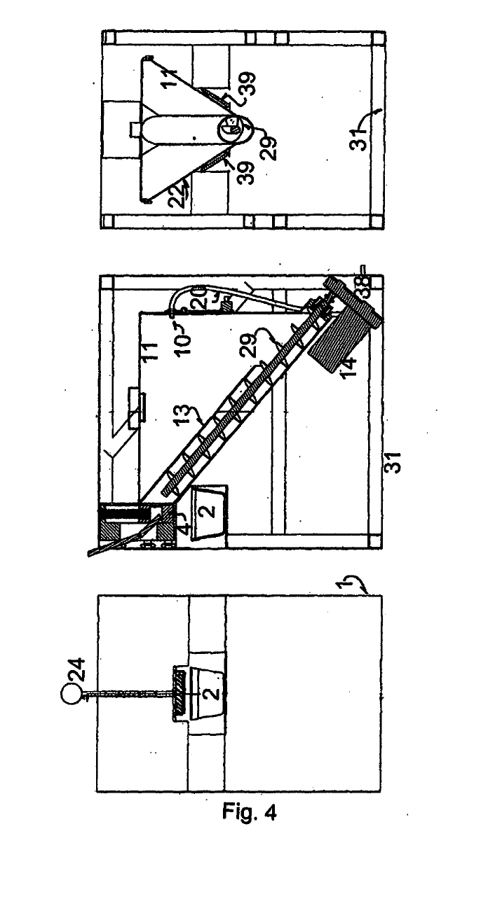

FIG. 5 shows details of the endless screw that is responsible for transferring the main ingredients outward and the arrangement of the driving motor and the front assembly containing the hatch, lever and the outlet spout.

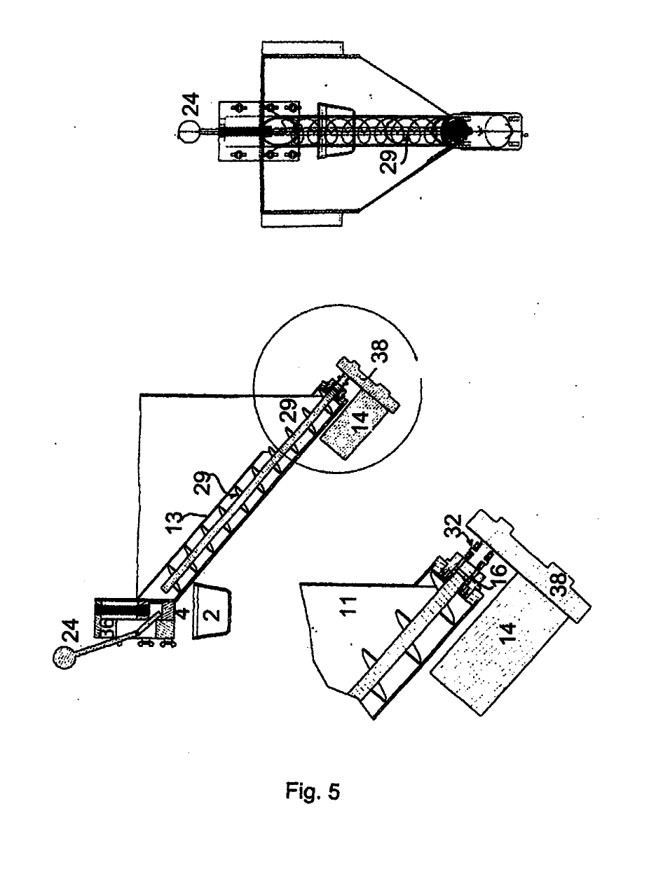

FIG. 6 shows various views of the assembly containing the hatch, the spout and the control lever.

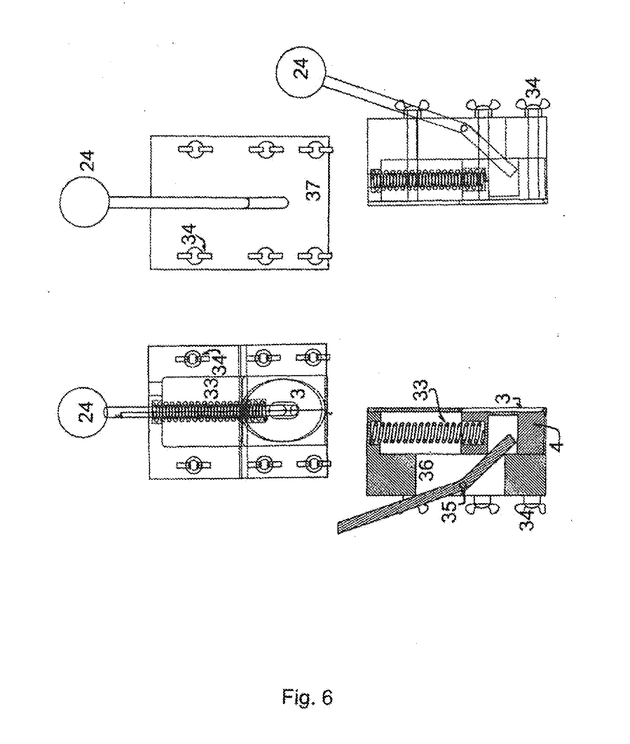

FIG. 7 shows the complete module of the container main equipped with the motor drive formed by the motor and gearbox assembly and the front assembly containing the hatch, spout and control lever.

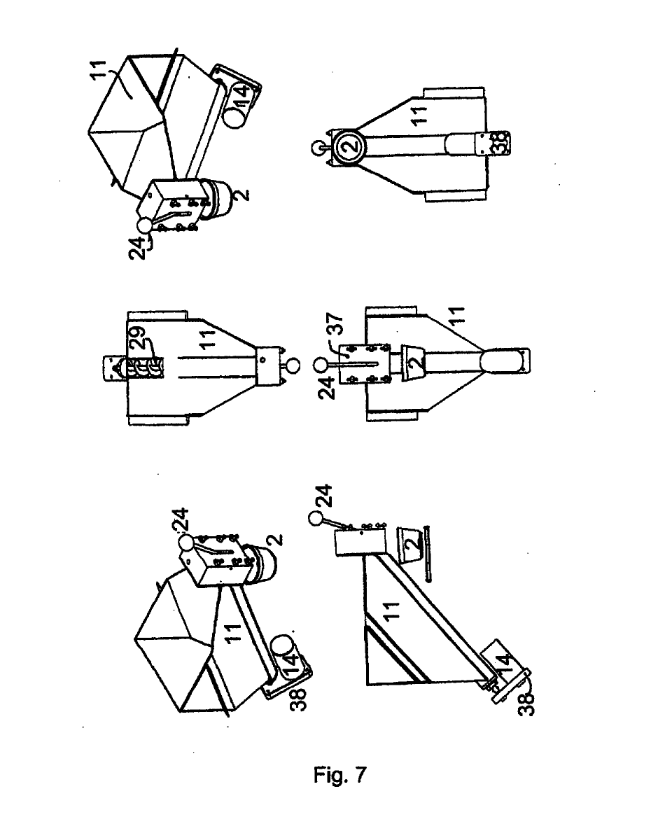

FIG. 8 shows the support structure in charge of holding the main container in position.

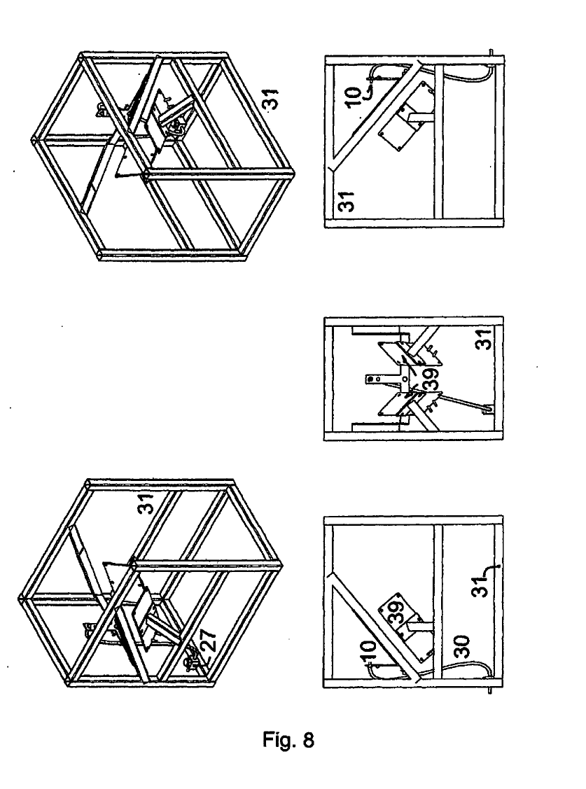

FIG. 9 shows a detail of the endless screw, one of the coupling systems with the drive unit and the transfer tube.

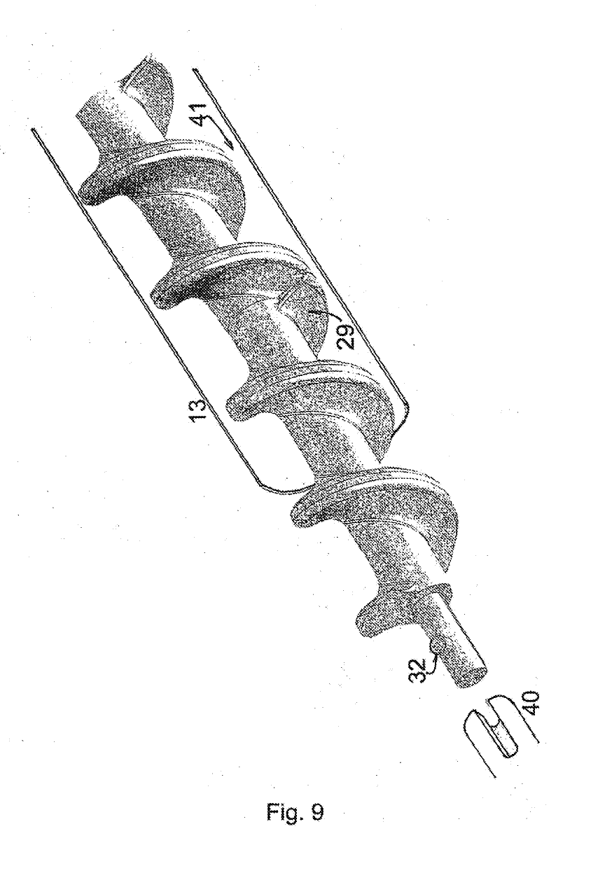

FIG. 10 shows a complete block diagram, which includes the electronic control and communication elements as well as a central computer that controls all whole.

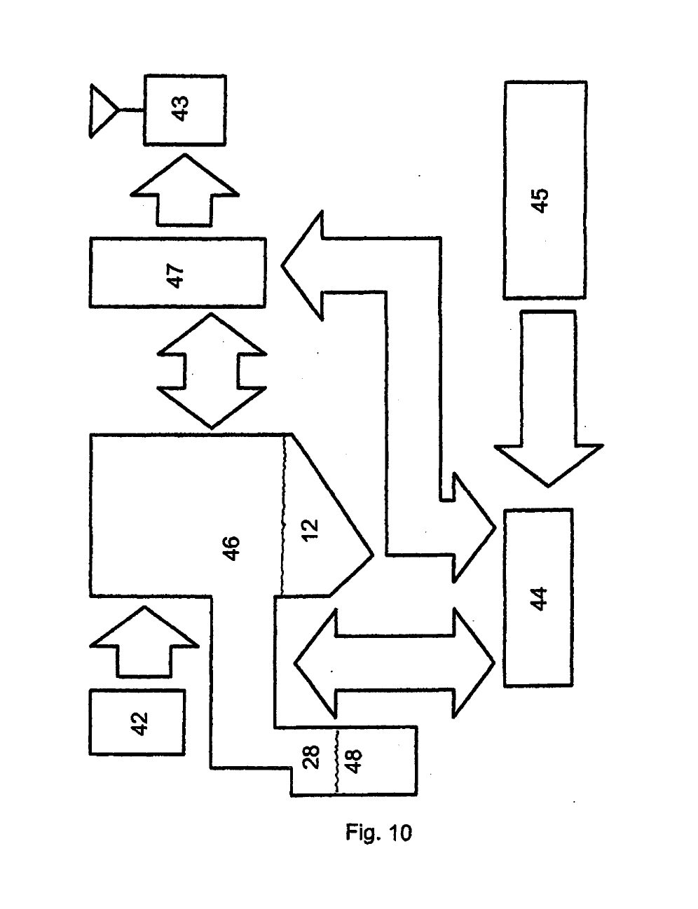

FIG. 11 shows the support structure covered by external panels covering the entire mechanism.

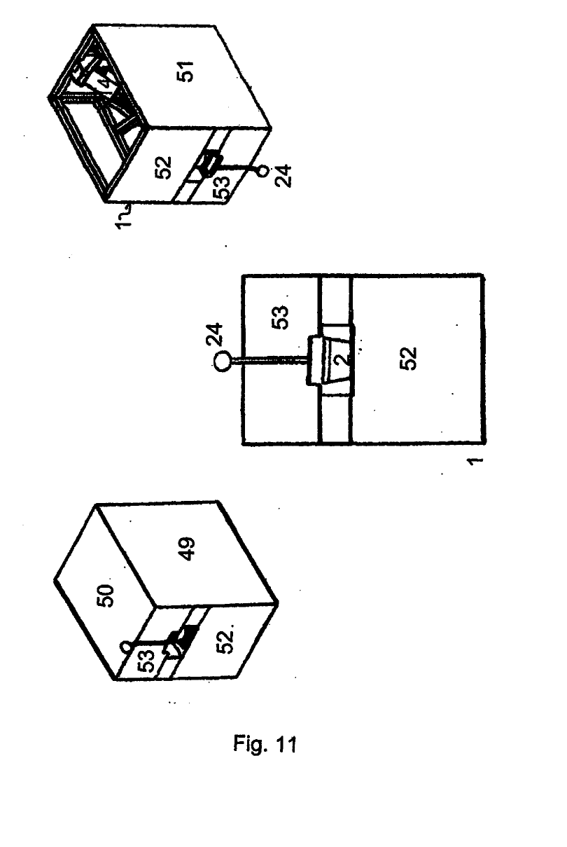

1. A dispenser of ingredients for the self-preparation of food at sales point said dispenser comprising:
a conical geometry container essentially funnel-shaped with its apex downwards, inside which a liquid with food granules is deposited which can be preserved inside at a predetermined high temperature and controlled by an automatic action thermostatic device that acts as a temperature controller so that if the temperature drops below a certain limit thermal sensor automatically actuates a heating device to raise the temperature of the liquid with granulated food to the predetermined level;
container walls being constituted of a double wall with an insulating material in between to help maintain the predetermined high temperature with minimal use of the heating device;
the container further includes a level sensor for maintaining the liquid level within a certain prescribed range, automatically activating a pump that transfers necessary fluid from an outer tank into the container;
the container further has inside an endless screw partially housed in a tube which is placed along one of the sloping walls of the container so that an uncovered part of the endless screw is oriented towards a bottom of the container while a part of the endless screw covered by the tube is directed towards an outlet spout, so that if the endless screw rotates in one direction, the food material stored in the container bottom is propelled by the endless screw and introduced into the tube partially surrounding the endless screw;
whereby the tube and the endless screw are designed so that part of the food material is propelled towards the outlet spout when the endless screw rotates while a sieve effect may be produced by the existence of a small gap between the tube and the endless screw allowing some of the liquid food material back into or remaining inside the container or by the presence on the tube of a series of perforations through which the liquid is returned into the container depending on these characteristics of the tube and the endless screw, the solid-to-liquid ratio of the material propelled into the spout is controlled;
the endless screw being driven by a drive unit consisting of an electric motor and a mechanical gearbox that allows the drive unit to have sufficient torque to move the endless screw depending on the density and consistency of the food mixture which is inside the container;
the drive unit being placed outside the container and having an axle or drive shaft that penetrates the wall of the container through a hydraulic seal that allows it to rotate without allowing the liquid inside the container to leak through a space between the shaft and the wall of the container; and
the motor and the endless screw are further characterised by the latter being united to the motor shaft by a quick-release coupling mechanism consisting of a slotted cylinder and transverse pin or by coupling mechanism consisting of a reverse thread to allow easy separation of the endless screw and the drive unit.

2. A dispenser of ingredients for the self-preparation of food at sales point, as described in claim 1, further having an outlet spout assembly placed at an end of the tube containing the endless screw used to propel the food material outside the container and being formed by a hatch that blocks the outlet port where the tube discharges the material; this hatch normally remaining closed through the action of a spring; a lever allows the hatch to be moved by overcoming the force of the spring which keeps it in closed position until it frees the path from the outlet tube to the outlet spout while moving the hatch operates a switch which actuates the drive unit such so that when this occurs, the endless screw starts rotating and propels the food material through the spout below which there is a specially designed space to place a container for the food material and complete its preparation.

3. A dispenser of ingredients for the self-preparation of food at sales point, as described in claim 1 further including the conical container, the drive unit, the endless screw, the food transport tube and the spout and hatch assembly forming a modular unit housed in a support structure providing protection and structural rigidity, said structure covered with external panels for advertising purposes that cover and protect the container when fitted inside and the panels can be used to display the instructions for use of equipment; the support structure being a second module designed to facilitate both installation and operation of the equipment and removal of the container module for cleaning and maintenance purposes.

4. A dispenser of ingredients for the self-preparation of food at sales point, as described in claims 1, further having a central computer that controls the liquid level and temperature, records services performed, detects faults in the equipment and lack of food material and also has an operational interface which allows voltage loads to be applied as well as communicating via the internet or mobile phone network to remotely notify a status of the equipment and its requirements; the central computer interacts with automatic payment units.

5. A dispenser of ingredients for the self-preparation of food at sales point, as described in claim 1, having dispensers for complementary seasonings, ingredients and flavourings
